(19) United States
(12) Patent Application Publication
(10) Pub. No.: US 2021/0318482 A1
(43) Pub. Date: Oct. 14, 2021

(54) LIGHT APPARATUS COMPRISING A LIGHT GUIDE PLATE WITH GROOVES AND METHODS FOR USING THE SAME TO DIRECT LIGHT

(71) Applicant: CORNING INCORPORATED, CORNING, NY (US)

(72) Inventor: Shenping Li, Painted Post, NY (US)

(21) Appl. No.: 17/265,108

(22) PCT Filed: Jul. 30, 2019
(86) PCT No.: PCT/US2019/044028

§ 371 Date: Feb. 1, 2021

Related U.S. Application Data
(60) Provisional application No. 62/713,614, filed on Aug. 2, 2018.

(51) Int. Cl. F21V 8/00

(52) U.S. Cl. CPC G02B 6/0036; G02B 6/0055

(57) ABSTRACT

A light apparatus can comprise a light source and a light guide plate, which can further comprise a major surface comprising a plurality of grooves. Each groove of the plurality of grooves may comprise a first surface and an opposed second surface. Each groove can have a maximum depth that may be defined between the second major surface and abase of the corresponding groove. In some embodiments, one or more surfaces of each groove may comprise a first convex portion. In other embodiments, the maximum depth of each groove of the plurality of grooves can be from about 1 micrometer to about 50 micrometers. In still other embodiments, the light apparatus may be used to direct light out of the light guide plate with a peak radiance oriented from 0° to 30° from a direction normal to the first major surface of the light guide plate.

### CROSS-REFERENCE TO RELATED APPLICATIONS

This application claims the benefit of priority of U.S. Provisional Application Ser. No. 62/713,614 filed on Aug. 2, 2018 the contents of which are relied upon and incorporated herein by reference in their entirety as if fully set forth below.

### FIELD

The present disclosure relates generally to a light apparatus comprising a light guide plate with grooves and methods for using the same to direct light and, more particularly, to a light apparatus comprising a light guide plate comprising grooves with each groove further comprising two surfaces and a base as well as methods for using the same to direct light.

### BACKGROUND

It is known to use a light apparatus in display devices including liquid crystal displays (LCDs) and the like to light a display. For compactness, such light apparatuses often employ a light source that emits into an edge of the light guide plate to propagate light through the light guide plate.

### SUMMARY

The following presents a simplified summary of the disclosure to provide a basic understanding of some embodiments described in the detailed description.

In accordance with some embodiments, a light apparatus may comprise a light guide plate and a light source. The light guide plate may further comprise a first major surface, a second major surface, and a first edge extending between the first major surface and the second major surface. The second major surface of the light guide plate may further comprise a plurality of grooves, where each groove of the plurality of grooves can comprise a first surface and a second surface opposed to the first surface. The first surface of each groove can further comprise a first convex portion. A maximum depth of each groove may be defined between a base of the corresponding groove and the second major surface of the light guide plate. Further, the light source can be positioned to emit light into the first edge of the light guide plate.

In some embodiments, the maximum depth of each groove in the light guide plate of the light apparatus can be from about 1 micrometer (micron) to about 50 micrometers.

In further embodiments, a depth angle of the first convex portion of the first surface of each groove in the light guide plate of the light apparatus can be from about 10° to about 55°.

In further embodiments, the first convex portion of the first surface of each groove in the light guide plate of the light apparatus may comprise a radius of curvature.

In still further embodiments, the radius of curvature of the first convex portion of the first surface of each groove in the light guide plate of the light apparatus may be equal to the maximum depth of the corresponding groove.

In other embodiments, the first convex portion of the first surface of each groove in the light guide plate of the light apparatus can be closer to the light source than the second surface of the corresponding groove.

In other embodiments, the second surface of each groove in the light guide plate of the light apparatus can comprise a second convex portion.

In further embodiments, a depth angle of the second convex portion of the second surface of each groove in the light guide plate of the light apparatus can be from about 1° to about 55°.

In some further embodiments, the depth angle of the first convex portion of the first surface of each groove of the plurality of grooves can change as a function of the distance of the groove from the first edge.

In yet other further embodiments, the depth angle of the first convex portion of the first surface and the depth angle of the second convex portion of the second surface may be the same for each groove in the light guide plate of the light apparatus.

In still other further embodiments, the first convex portion of the first surface and the second convex portion of the second surface of each groove can meet at the base of the corresponding groove in the light guide plate of the light apparatus.

In other embodiments, the pair of surfaces of each groove of the plurality of grooves can meet at the base of the corresponding groove in the light guide plate of the light apparatus.

In still other embodiments, the base of each groove in the light guide plate of the light apparatus can comprise a cusp.

In other embodiments, a light apparatus may comprise a light guide plate and a light source. The light guide plate can further comprise a first major surface, a second major surface, and a first edge extending between the first major surface and the second major surface. The second major surface may further comprise a plurality of grooves. Each groove of the plurality of grooves can further comprise a maximum depth from about 1 micrometer to about 50 micrometers. The light source can be positioned to emit light into a first edge of the light guide plate.

In further embodiments, the light apparatus may further comprise a reflector that can face the second major surface of the light guide plate.

In other embodiments, the grooves of the plurality of grooves in the light guide plate of the light apparatus can be spaced apart from one another and extend substantially parallel to the first edge.

In still other embodiments, the first edge of the light guide plate in the light apparatus may be substantially straight.

In other embodiments, the first and second major surfaces of the light guide plate can each comprise a quadrilateral shape. The light guide plate may further comprise a second edge extending between the first and second major surfaces. Opposite the first edge, the light guide plate can have a third edge extending from the first edge to the second edge and a fourth edge opposite the third edge. A length of the light guide plate may be defined between the first edge and the second edge. A width of the light guide plate may be defined between the third edge and the fourth edge.

In further embodiments, a spacing between pairs of adjacent grooves of the plurality of grooves along the length of the light guide plate of the light apparatus decreases as a distance of the pair of adjacent grooves from the first edge increases.

In other further embodiments, the spacing between the pairs of adjacent grooves along the length of the light guide plate is from about 10 micrometers to about 5 millimeters.

In further embodiments, each groove of the plurality of grooves continuously extends for a length along a corresponding groove path from the third edge to the fourth edge of the light guide plate of the light apparatus.

In further embodiments, the length of each groove of the plurality of grooves is equal to the width of the light guide plate of the light apparatus.

In other further embodiments, each groove of the plurality of grooves is separated from another groove of the plurality of grooves in the same groove path in the light guide plate of the light apparatus by about 50 micrometers to about 100 millimeters.

In still other further embodiments, a groove in a first groove path is staggered in a direction of the width of the light guide plate from a groove in a second groove path adjacent to the first groove path of the light guide plate of the light apparatus.

In yet other further embodiments, the maximum depth of each groove of the plurality of grooves can be between about 1 micron and about 30 microns.

In other embodiments, the maximum depth of each groove of the plurality of grooves can increase as a distance of the groove from the first edge increases.

In accordance with some embodiments, methods of emitting light with may involve using one of the light apparatuses discussed above. Methods may involve injecting light emitted from the light source through the first edge of the light guide plate and into the light guide plate. Also, methods can involve propagating light into the light guide plate by total internal reflection. At least a portion of the light in the light guide plate may exit the light guide plate into at least one groove of the plurality of grooves in the light guide plate. Such methods can direct at least 20% of the light exiting the light guide plate into at least one groove back into the light guide plate.

In further embodiments, methods can further comprise passing the light in the light guide plate through the first major surface of the light guide plate with a peak radiance oriented from about 0° to about 30° from a direction normal to the first major surface of the light guide plate.

In other further embodiments, methods can direct at least 50% of the propagating light exiting the light guide plate into the at least one groove is directed back into the light guide plate.

In accordance with other embodiments, methods of emitting light may involve using one of the light apparatuses discussed above. Method may involve injecting light emitted from the light source through the first edge of the light guide plate and into the light guide plate. Also, methods can involve propagating light within the light guide plate by total internal reflection. Additionally, methods can involve passing the light in the light guide plate through the first major surface of the light guide plate with a peak radiance oriented from about 0° to about 30° from a direction normal to the first major surface of the light guide plate.

In further embodiments, the peak radiance can be oriented from about 0° to about 10° from a direction normal to the first major surface of the light guide plate.

### BRIEF DESCRIPTION OF THE DRAWINGS

These and other features, aspects and advantages are better understood when the following detailed description is read with reference to the accompanying drawings, in which:

FIG. 1 illustrates a cross-sectional side view of an example embodiment of a light apparatus including a light guide plate with a second major surface including a plurality of grooves;

FIG. 2 is an enlarged view 2 of FIG. 1 illustrating a surface profile of a groove of the plurality of grooves in accordance with a first example embodiment of the light apparatus;

FIG. 3 is an alternative enlarged view 2 of FIG. 1 illustrating a surface profile of a groove of the plurality of grooves in accordance with a second example embodiment of the light apparatus;

FIG. 4 is an alternative enlarged view 2 of FIG. 1 illustrating a surface profile of a groove of the plurality of grooves in accordance with a third example embodiment of the light apparatus;

FIG. 5 is an alternative enlarged view 2 of FIG. 1 illustrating a surface profile of a groove of the plurality of grooves in accordance with a fourth example embodiment of the light apparatus;

FIG. 6 is an alternative enlarged view 2 of FIG. 1 illustrating a surface profile of a groove of the plurality of grooves in accordance with a fifth example embodiment of the light apparatus;

FIG. 7 is an alternative enlarged view 2 of FIG. 1 illustrating a surface profile of a groove of the plurality of grooves in accordance with a sixth example embodiment of the light apparatus;

FIG. 8 illustrates a cross-section taken along the line 8-8 in FIG. 1 showing a first example embodiment of an arrangement of the plurality of grooves of the second major surface of the light guide plate;

FIG. 9 illustrates another cross-section taken along the line 8-8 in FIG. 1 showing a second example embodiment of an arrangement of the plurality of grooves of the second major surface of a light guide plate;

FIG. 10 illustrates the angular distribution of light leaving the first major surface of a light guide plate when the second major surface has inclined grooves with a maximum depth of 5 micrometers (microns) for different depth angles;

FIG. 11 illustrates the angular distribution of light leaving the first major surface of a light guide plate when the second major surface has concave grooves with a maximum depth of 5 microns for different depth angles;

FIG. 12 illustrates the angular distribution of light leaving the first major surface of a light guide plate when the second major surface has convex grooves with a maximum depth of 5 microns for different depth angles;

FIG. 13 illustrates the angular distribution of light leaving the first major surface of a light guide plate when the second major surface has either inclined or concave grooves with a depth angle of 35° for different maximum depths;

FIG. 14 illustrates the percentage of light exiting the light guide plate into a convex groove that is directed back into the light guide plate as a function of a depth angle of the convex groove; and

FIG. 15 illustrates the percentage of light exiting the light guide plate into a convex groove that is directed back into the light guide plate as a function of a width of the groove.

### DETAILED DESCRIPTION

Embodiments will now be described more fully hereinafter with reference to the accompanying drawings in which example embodiments are shown. Whenever possible, the same reference numerals are used throughout the drawings to refer to the same or like parts. However, this disclosure may be embodied in many different forms and should not be construed as limited to the embodiments set forth herein.

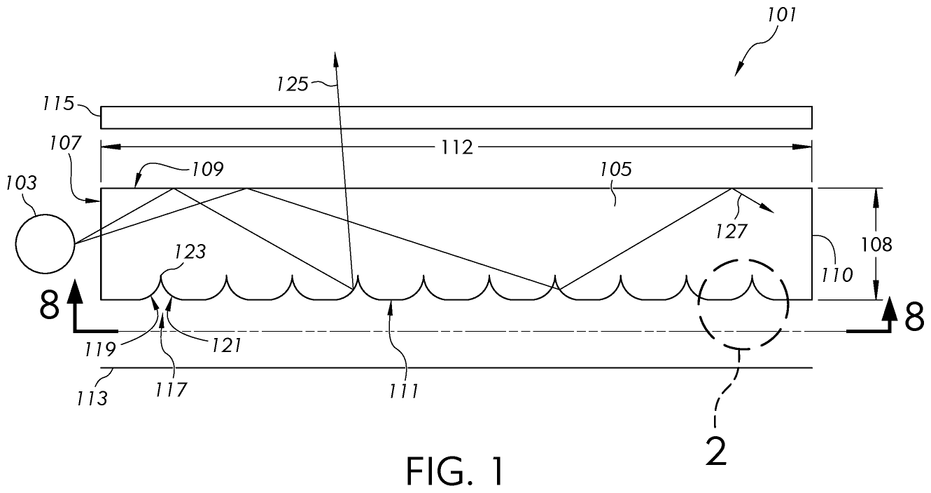

By way of example, FIG. 1 schematically illustrates a cross-sectional side view of an example embodiment of a light apparatus 101. The light apparatus 101 can comprise a light guide plate 105 including a first major surface 109, and a second major surface 111 that is opposite the first major surface 109. As shown, the first major surface 109 can extend along a first flat plane and the second major surface 111 can extend along a second flat plane. Although not shown, in some embodiments, the first and second major surfaces 109, 111 may extend along a curved plane. Furthermore, as shown, the first major surface 109 can extend parallel to the second major surface 111, wherein a thickness 108 can be defined between the first major surface 109 and the second major surface 111 between an adjacent pair of grooves, defined below. In such examples, the thickness 108 can be within a range of 100 micrometers (microns) to about 10 millimeters, although other thicknesses may be provided in further embodiments. In some embodiments, the thickness 108 can be between about 200 microns and about 6 microns, between about 200 microns and about 3 millimeters, between about 200 microns and about 800 microns, or between about 200 microns and about 500 microns. In other embodiments, the thickness 108 can be about 10 millimeters or less, about 6 millimeters or less, about 3 millimeters or less, about 2 millimeters or less, about 1 millimeter or less, about 500 microns or less, or about 200 microns or less. In embodiments where a small thickness is desirable, the thickness 108 may preferably be about 1 millimeter or less, about 500 microns or less, or even about 200 microns or less. In still other embodiments, the thickness 108 can be about 100 microns or more, about 200 microns or more, about 500 microns or more, about 1 millimeter or more, about 2 millimeters or more, about 3 millimeters or more, or about 6 millimeters or more. Furthermore, the thickness 108 can be substantially constant along a significant amount of the light guide plate 105 due to the substantially parallel arrangement of the first and second major surfaces 109, 111, as shown. Although not shown, rather than extending parallel to one another, the first major surface 109 and the second major surface 111 between each adjacent pairs of grooves may extend at an acute angle relative to one another, wherein the thickness 108 can vary along a length and/or a width of the light guide plate 105. In further embodiments, the acute angle between one adjacent pair of grooves on the second major surface 111 may be different than another acute angle between a second adjacent pair of grooves on the second major surface 111. In other embodiments, the first major surface 109 may comprise grooves comprising surfaces with combinations of convex, concave, and inclined portions, including those illustrated for the second major surface 111 and described below.

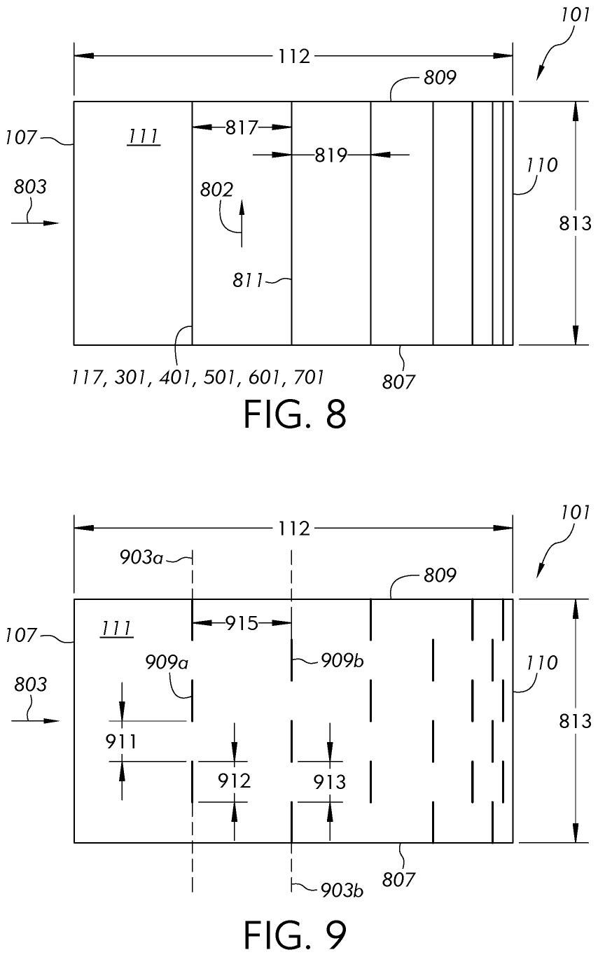

The major surfaces of the light guide plate can comprise a wide range of shapes such as polygonal with three or more sides (e.g., triangular, quadrilateral), curvilinear (e.g., circular, elliptical) or a shape have a combination of polygonal and curvilinear features. As shown in FIGS. 1 and 8-9, the first major surface 109 and the second major surface 111 of the light guide plate 105 may each comprise a rectangular shape. In such embodiments, a first edge 107 and a second edge 110 of the light guide plate 105 may each extend between the first major surface 109 and the second major surface 111. The first edge 107 and the second edge 110 can comprise straight edges that are parallel relative to one another. Furthermore, the second edge 110 may be positioned opposite the first edge 107 to define a length 112 of the light guide plate 105. As shown in FIGS. 8-9, the light guide plate 105 may further include a third edge 807 and a fourth edge 809 that can each extend between the first major surface 109 and the second major surface 111. The third edge 807 and the fourth edge 809 can comprise straight edges that are parallel relative to one another. Furthermore, the fourth edge 809 may be positioned opposite the third edge 807 to define a width 813 of the light guide plate 105. As such, the edges 107, 110, 807, 809 can likewise form a rectangular shape with each of the third edge 807 and the fourth edge 809 extending from the first edge 107 to the second edge 110 while being perpendicular to the first and second edges 107, 110. In some embodiments, the length 112 of the light guide plate 105 can be about the same as, greater than, or less than the width 813 of the light guide plate 105. In some embodiments, the length 112 and the width 813 of the light guide plate 105 may be equal to the corresponding measurements of an associated display 115, although other lengths may be provided in further embodiments. The length 112 of the light guide plate 105 can be between about 100 microns to about 3 meters, between about 1 millimeters and about 2.05 meters, between about 10 millimeters and about 1.22 meters, or between about 25 millimeters and about 300 millimeters. In some embodiments, the width 813 of the light guide plate 105 can be between about 100 microns to about 3 meters, between about 1 millimeters and about 2.05 meters, between about 10 millimeters and about 1.22 meters, or between about 25 millimeters and about 300 millimeters.

The light guide plate 105 can comprise a wide range of materials that provide desired optical properties. In some embodiments, the light guide plate 105 can comprise an amorphous inorganic material (e.g., glass), a crystalline material (e.g., sapphire, single crystal or polycrystalline alumina, spinel (MgAl₂O₄), quartz), or a polymer. Embodiments of suitable polymers include, without limitation, the following as well as copolymers and blends thereof: thermoplastics including polystyrene (PS), polycarbonate (PC), polyesters including polyethyleneterephthalate (PET), polyolefins including polyethylene (PE), polyvinylchloride (PVC), acrylic polymers including polymethyl methacrylate (PMMA), thermoplastic urethanes (TPU), polyetherimide (PEI), epoxies, and silicones including polydimethylsiloxane (PDMS). Embodiments of glass, which may be strengthened or non-strengthened and may be free of lithia or not, include soda lime glass, alkali aluminosilicate glass, alkali containing borosilicate glass and alkali aluminoborosilicate glass. As used herein, the term “strengthened” when applied to a substrate, for example glass or another transparent layer, may refer to a substrate that has been chemically strengthened, for example through ion-exchange of larger ions for smaller ions in the surface of the substrate. However, other strengthening methods known in the art, for example thermal tempering, or utilizing a mismatch of the coefficient of thermal expansion between portions of the substrate to create compressive stress and central tension regions, may be utilized to form strengthened substrates.

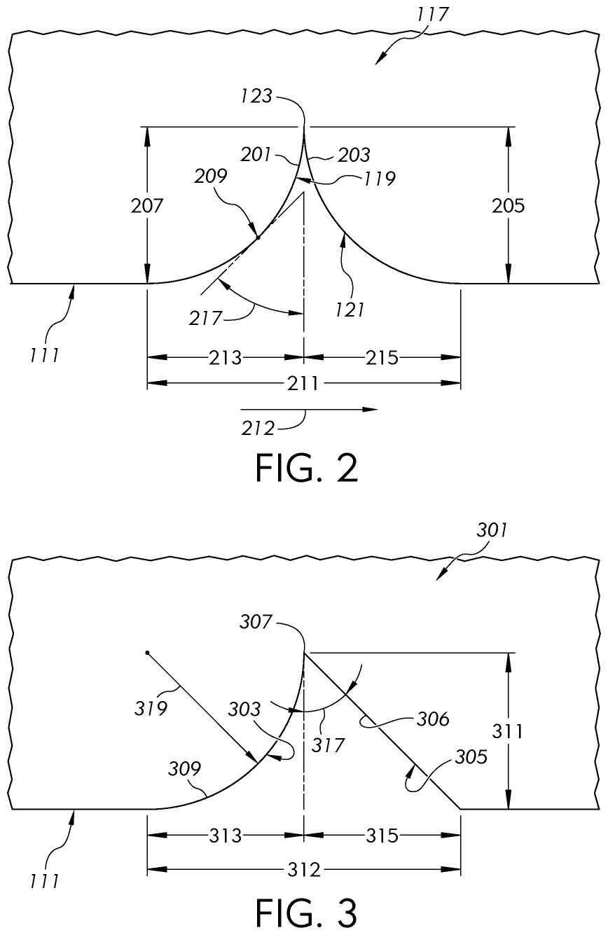

With initial reference to FIG. 1, the second major surface 111 of the light guide plate 105 comprises a plurality of grooves 117. Each groove of the plurality of grooves 117 may comprise a first surface 119, a second surface 121 opposite the first surface, and a base 123. Generally referring to view 2 of FIG. 1, various example embodiments of surface profiles of a groove of the plurality of grooves 117 in accordance with various embodiments of the light apparatus are illustrated in FIGS. 2-7. In some embodiments, all the grooves of the plurality of grooves 117 may have the same surface profile. Alternatively, the surface profile of one groove of the plurality of grooves may be different than the surface profile of another groove of the plurality of grooves. For example, embodiments may combine one or more surface profiles described with respect to one of FIGS. 2-7 with one or more other surface profiles discussed with respect to another one of FIGS. 2-7.

FIG. 2 illustrates an embodiment of a surface profile of the groove 117 that can comprise one or more of the shapes of the first surface 119, the second surface 121, and the base 123 shown. Throughout the disclosure, a maximum depth of a groove is defined as the distance between the second major surface 111 of the light guide plate 105 and the base along a direction perpendicular to the second major surface 111. For example, with reference to FIG. 2, a maximum depth 205 of the groove 117 is defined as the distance between the second major surface 111 of the light guide plate 105 and the base 123 of the corresponding groove 117 in a direction perpendicular to the second major surface 111 of the light guide plate 105. Throughout the disclosure, unless otherwise noted, the maximum depth of the groove of each embodiment of the disclosure may be about 50 microns or less, about 40 microns or less, or about 30 microns or less, between about 1 micron and about 50 microns, between about 5 microns and about 40 microns, or between about 10 microns and about 30 microns.

Also, throughout the disclosure a groove width is defined as the maximum distance between a first point on the first surface of the groove and a second point on the first surface of the groove along a direction perpendicular to an elongated direction of the groove and parallel to the second major surface of the light guide plate 105, where the first point and the second point are as far apart as possible. For instance, with reference to FIG. 2, a groove width 211 can be the distance between a first point on the first surface 119 and a second point on the second surface 121 of the corresponding groove 117 along a direction 212 that is perpendicular to an elongated direction 802 (see FIG. 8) of the groove 117, where the first point and the second point are as far apart as possible. Likewise, a first width 213 may be associated with the first surface 119 and a second width 215 may be associated with the second surface 121. A first width 213 can be the distance between a first point on the first surface 119 and a second point on the first surface 119 of the along a direction 212 that is perpendicular to an elongated direction 802 (see FIG. 8), where the first point and the second point are as far apart as possible. Likewise, a second width 215 can be the distance between a first point on the second surface 121 and a second point on the second surface 121 of the along a direction 212 that is perpendicular to an elongated direction 802 (see FIG. 8), where the first point and the second point are as far apart as possible. In some embodiments, as shown in FIG. 2, the sum of the first width 213 associated with the first surface 119 and the second width 215 associated with the second surface 121 can be about equal to the groove width 211 of the corresponding groove 117.

In some embodiments, the first surface 119 of the groove 117 may comprise a first convex portion 201. Throughout the disclosure, tangent angles (i.e., angles tangent to a portion) are measured relative to a direction perpendicular to the second major surface 111 of the light guide plate 105. The first convex portion 201 can have a tangent angle that monotonically increases as it goes from a first point nearer to the second major surface 111 of the light guide plate 105 to a second point nearer to the base 123 of the corresponding groove 117, and the tangent angle at the second point is closer to 0° than the tangent angle at the first point. In further embodiments, the angle tangent to the first point nearer the second major surface 111 of the light guide plate 105 can be about 90° and the angle tangent to the second point nearer the base 123 of the corresponding groove 117 can be about 0°. In other embodiments, the angle tangent to a point on the first convex portion 201 can continuously increase as the chosen point is moved closer to the second major surface 111 of the light guide plate 105. Throughout the disclosure, a quantity that increases monotonically never decreases while a quantity that decreases monotonically never increases.

Also, a portion within the light guide plate 105 bounded by the first convex portion 201 of the first surface 119 of a groove 117 can have a property that any two points in the first convex portion 201 can be connected by a line that is entirely within the first convex portion 201 and does not cross the first surface 119 of the corresponding groove 117. In some embodiments, the first convex portion 201 may have a maximum depth 207. Throughout the disclosure, the maximum depth of a convex portion is the maximum distance between a first point on the convex portion and a second point on the convex portion in a direction perpendicular to the second major surface 111 of the light guide plate 105, where the first point and the second point are as far apart as possible. Referring to FIG. 2, the maximum depth 207 of the first convex portion can correspond to the maximum distance between two points in the first convex portion 201 of the first surface 119 in a direction perpendicular to the second major surface 111, where the first point and the second point are as far apart as possible. As shown in FIG. 2, in some embodiments, the first convex portion 201 may include the entire first surface 119 of the groove 117, although the first convex portion 201 may include less than the entire first surface in further embodiments. The maximum depth 207 of the first convex portion 201 can be the same along the length of the groove 117, perpendicular to the surface profile shown in FIG. 2. As further illustrated, in some embodiments, the maximum depth 207 of the first convex portion 201 can be substantially the same as the maximum depth 205 of the groove 117 although the maximum depth 207 of the first convex portion 201 may be less than the maximum depth 205 of the groove 117 in further embodiments. In other further embodiments, the second surface 121 can comprise a second convex portion 203 that can have similar or identical features as the first convex portion 201 discussed above. For instance, as shown in FIG. 2, in some embodiments, the second convex portion 203 can comprise a mirror image of the first convex portion 201. As shown in FIG. 2, in some embodiments, the second convex portion 203 may include the entire second surface 121 of the groove 117, although the second convex portion may include less than the entire second surface in further embodiments. In still further embodiments, the first convex portion 201 and the second convex portion 203 of the corresponding groove 117 can be symmetrically disposed about a plane bisecting the base 123 of the groove 117. Throughout the disclosure, the width of a convex portion is defined as the maximum distance between a first point on the convex portion and a second point on the convex portion in a direction that is perpendicular to an elongated direction 802 (see FIG. 8) and parallel to the first major surface 109, where the first point and the second point are as far apart as possible.

The first convex portion 201 and the second convex portion 203 may be provided with a depth angle that, as shown, can be identical, although different depth angles may be provided in further embodiments. The depth angle 217 of the first convex portion 201 will be described with the understanding that such description can also apply to the depth angle of the second convex portion 203. For instance, with reference to FIG. 2, the first convex portion 201 of the first surface 119 of the groove can be characterized by a depth angle 217. Throughout the disclosure, a depth angle of a convex portion of a surface of a groove is defined as a tangent angle relative a direction perpendicular to the second major surface 111 of the light guide plate 105 measured at a first point in the convex portion that is 29.2% of the maximum depth of the convex portion of the groove from a second point in the convex portion that is closest to the second major surface 111 of the light guide plate 105. 29.2% (i.e., 1-2^{-1/2} as a percentage) of the maximum depth of the convex portion corresponds to a location where a tangent angle will be 45° relative to a direction perpendicular to the second major surface 111 when the surface profile of convex portion comprises a radius of curvature (e.g., see FIG. 3). Referring to FIG. 2, the depth angle 217 of the first convex portion 201 is a tangent angle relative to a direction perpendicular to the second major surface 111 of the light guide plate 105 measured at a point 209 on the first convex portion 201 of the first surface 119 that is 29.2% of the maximum depth 207 of the first convex portion 201 from the second major surface 111 of the light guide plate 105 since the first convex portion 201 is shown as including the entire first surface 119 of the groove 117. In some embodiments, the depth angle 217 may be the same as an angle between a line perpendicular to the second major surface 111 of the light guide plate 105 and a line having a slope equal to the average slope of the first convex portion 201 of the first surface 119. In further embodiments, the first convex portion 201 may include the entire first surface 119 and the average slope of the first convex portion 201 may be equal to the maximum depth 205 of the groove 117 divided by the first width 213 of the first surface 119 of the corresponding groove 117.

Throughout the embodiments of the grooves of the disclosure, unless otherwise noted, the depth angle of a first convex portion (e.g., depth angle 217, 619, 623, 721 of first convex portions 201, 607, 707 of the corresponding groove 117, 601, 701 shown in FIGS. 2 and 6-7) may be about 10° or more, about 20° or more, about 30° or more, about 35° or more, about 55° or less, about 50° or less, between about 10° and about 55°, between about 20° and about 55°, between about 10° and about 50°, between about 20° and about 50°, between 30° and about 50°, or between about 35° and about 50°. In other embodiments, unless otherwise noted, the depth angle of any of the embodiments of the grooves of the disclosure can be about 80° or less, about 70° or less, about 60° or less, about 55° or less, or about 50° or less. In still other embodiments, unless otherwise noted, the depth angle of any of the embodiments of the grooves of the disclosure can be between about 0° and about 80°, between about 10° and about 60°, between about 10° and about 55°, between about 10° and about 50°, between about 30° and about 60°, between about 30° and about 55°, between about 30° and about 50°, between about 35° and about 55°, or between about 35° and about 50°. In further embodiments, the depth angle of a second convex portion (e.g., the second convex portion 121, 511, 609 of the corresponding groove 117, 501, 601 shown in FIGS. 2 and 5-6) may be between about 1° and about 55°, between about 10° and about 55°, between about 20° and about 55°, between about 10° and about 50°, between about 20° and about 50°, between 30° and about 50°, or between about 35° and about 50°.

FIG. 3 illustrates another embodiment of a surface profile of a groove 301 that can comprise one or more of the shapes of a first surface 303, a second surface 305, and a base 307 shown. In some embodiments, the first surface 303 can comprise a convex portion 309. In some embodiments, the convex portion 309 of the groove 301 can be identical to the first convex portion 201 of the groove 117 discussed above. In further embodiments, as shown, the convex portion 309 of the first surface 303 of a groove 301 may comprise a radius of curvature 319 wherein the convex portion 309 includes a cylindrical first surface 303. In such embodiments, all points on the surface profile of the convex portion 309 of the first surface 303 can be equidistance from a common point within the light guide plate 105, as shown in FIG. 3. In some further embodiments, the radius of curvature 319 can be the same along an elongated direction 802 (see FIG. 8), wherein the convex portion 309 of the first surface 303 comprises a circular cylinder. In other further embodiments, the radius of curvature 319 can change (e.g., monotonically) along an elongated direction 802 (see FIG. 8). In still other further embodiments, where the convex portion 309 includes the entire first surface 303, a first width 313 of the first surface 303 of the groove 301 can be the same as the maximum depth 311 of the corresponding groove 301 as well as the radius of curvature 319 for the convex portion 309. In such embodiments, the depth angle for the convex portion 309 may be about 45° or between about 40° and about 50°. The maximum depth of the convex portion 309 can be the same along the length of the groove 301, perpendicular to the surface profile shown in FIG. 3.

As further illustrated in FIG. 3, the second surface 305 can comprise an inclined portion 306. As shown, embodiments of the second surface 305 of the inclined portion 306 can comprise a substantially flat surface. As shown, in some embodiments, the inclined portion 306 may extend from the second major surface 111 of the light guide plate 105 to the base 307 of the groove 301. Throughout the disclosure, a depth angle of an inclined portion may be defined as the angle between the corresponding surface and a direction perpendicular to the second major surface 111 of the light guide plate 105. For instance, as shown in FIG. 3, the depth angle 317 of the inclined portion 306 of the second surface 305 of the groove 301 can be the angle between the direction perpendicular to the second major surface 111 of the light guide plate 105 and the inclined portion 306. In some embodiments, the depth angle 317 of the inclined portion 306 can be between about 0° and about 80°, between about 0° and about 60°, between about 0° and about 50°, between about 10° and about 80°, between about 10° and about 60°, or between about 10° and about 50°. Throughout the disclosure, a maximum depth of an inclined portion may be defined as the maximum distance between two points on the second surface 305 in the inclined portion 306 with the same tangent angle in a direction perpendicular to the second major surface 111, where the first point and the second point are as far apart as possible. The maximum depth of the inclined portion may be the same along the length of the groove 301, perpendicular to the surface profile shown in FIG. 3. Throughout the disclosure, the width of an inclined portion is defined as the maximum distance between a first point on the inclined portion and a second point on the inclined portion in a direction that is perpendicular to an elongated direction 802 (see FIG. 8) and parallel to the first major surface 109, where the first point and the second point are as far apart as possible. In some embodiments, as shown in FIG. 3, the sum of the first width 313 of the first surface 303 and the second width 315 associated with the second surface 305 can be about equal to the groove width 312 of the corresponding groove 301.

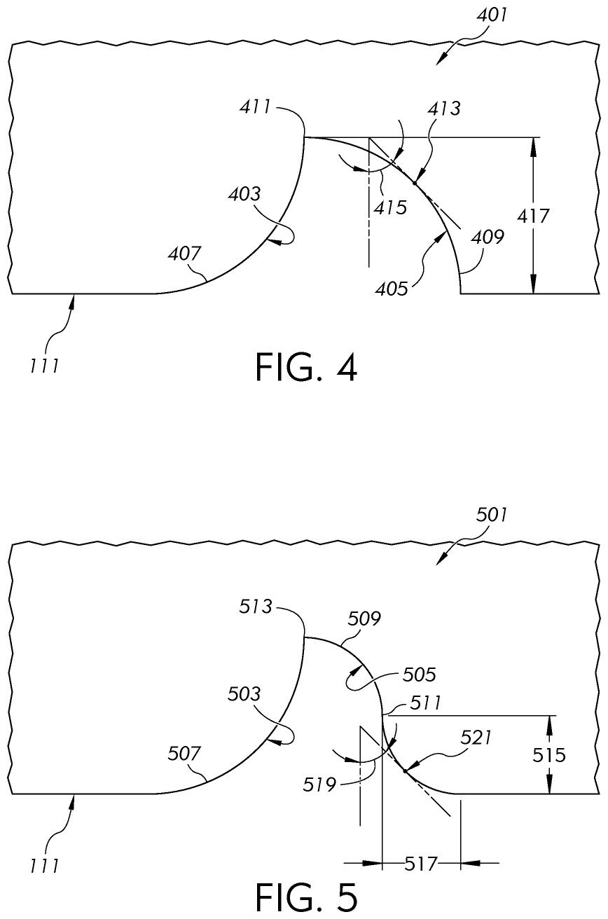

FIG. 4 illustrates another embodiment of a surface profile of a groove 401 that can comprise one or more of the shapes of a first surface 403, a second surface 405, and a base 411 shown. In some embodiments, the first surface 403 can comprise a convex portion 407 and the second surface 405 can comprise a concave portion 409. In some embodiments, the convex portion 407 of the groove 401 can be identical to the convex portion 309 of the groove 301 or the first convex portion 201 of the groove 117 discussed above. As such, the convex portion 407 can have a maximum depth associated with it and that maximum depth can be the same along the length of the groove 401, perpendicular to the surface profile shown in FIG. 4. The concave portion 409 of the groove 401 can have a tangent angle that monotonically increases (i.e., never decreases) as it goes from a first point nearer to the second major surface 111 of the light guide plate 105 to a second point nearer to the base 411 of the corresponding groove 401, meaning that the tangent angle at the first point is closer to 0° than the tangent angle at the second point. Also, a portion of the light guide plate 105 bounded by the concave portion 409 may not have a property that any two points in the portion can be connected by a line that is entirely within the concave portion 409 of the second surface 405 of the groove 401, meaning that some such lines will cross the concave portion 409 of the second surface 405.

Throughout the disclosure, the maximum depth of a concave portion is the maximum distance between a first point on the concave portion and a second point on the concave portion in a direction perpendicular to the second major surface of the light guide plate, where the first point and the second point are as far apart as possible. Referring to FIG. 4, the concave portion 409 may have a maximum depth 417 associated with it that can correspond to the distance between two points on the concave portion 409 of the second surface 405 in a direction perpendicular to the second major surface 111, where the points are as far apart as possible As shown in FIG. 4, in some embodiments, the concave portion 409 may include the entire second surface 405 of the groove 401 although the concave portion may include less than the entire second surface in further embodiments. The maximum depth of the concave portion 409 can be the same along the length of the groove 401, perpendicular to the surface profile shown in FIG. 4. As further illustrated, in some embodiments, the maximum depth 417 of the concave portion 409 can be substantially the same as the maximum depth of the groove 401, although the maximum depth 417 of the concave portion 409 may be less than the maximum depth of the groove 401 in further embodiments.

The concave portion 409 can include a depth angle 415. Throughout the disclosure, a depth angle of a concave portion of a surface of a groove is defined as a tangent angle relative to direction perpendicular to the second major surface 111 of the light guide plate 105 measured at a first point in the concave portion that is 29.2% of the maximum depth of the concave portion from a second point in the concave portion closest to the base of the corresponding groove. 29.2% (i.e., 1-2^{-1/2} as a percentage) of the maximum depth of the concave portion corresponds to a location where a tangent angle will be 45° relative to a direction perpendicular to the second major surface 111 when the surface profile of concave portion 409 comprises a radius of curvature. Referring to FIG. 4, the depth angle 415 of the concave portion 409 of the second surface 405 of the groove 401 is defined as a tangent angle relative to a direction perpendicular to the second major surface 111 of the light guide plate 105 measured at a point 413 in the concave portion 409 of the second surface 405 that is 29.2% of the maximum depth of the groove 401 from the base 411 of the corresponding groove 401 since the concave portion 409 is shown as including the entire second surface 405 of the groove 401. In some embodiments, the depth angle 415 of the concave portion 409 can be between about 0° and about 80°, between about 0° and about 60°, between about 0° and about 50°, between about 30° and about 60°, or between about 30° and about 50°. Throughout the disclosure, the width of a concave portion is defined as the maximum distance between a first point on the concave portion and a second point on the concave portion in a direction that is perpendicular to an elongated direction 802 (see FIG. 8) and parallel to the first major surface 109, where the first point and the second point are as far apart as possible.

FIG. 5 illustrates another embodiment of a surface profile of a groove 501 that can comprise one or more of the shapes of a first surface 503, a second surface 505, and a base 513 shown. The first surface 503 can comprise a first convex portion 507. In some embodiments, the first convex portion 507 of the groove 501 can be identical to the first convex portion 201 of the groove 117 or the convex portion 309 of the groove 301 discussed above. As such, the first convex portion 507 can have a maximum depth associated with it and that maximum depth can be the same along the length of the groove 501, perpendicular to the surface profile shown in FIG. 5.

As shown, the second surface 505 can comprise a compound shape that is not entirely convex, not entirely concave, and is not entirely inclined. In some embodiments, the compound shape can include a surface with at least two surfaces from the group of: a concave portion, a convex portion, and an inclined portion. For instance, as shown in the illustrated embodiment, the second surface 505 can include a second convex portion 511 and a concave portion 509.

The second convex portion 511 may have a width 517, a maximum depth 515, and a depth angle 519 measured using a tangent angle relative to a direction perpendicular to the first major surface 109 at a first point 521 on the second convex portion 511 that is 29.2% of the maximum depth 515 of the corresponding second convex portion 511 from a second point in corresponding second convex portion 511 that is closest to the second major surface 111 of the light guide plate 105, similar to the convex portions of the other embodiments discussed above. The width 517 of the second convex portion 511 can be the distance between a first point on the second convex portion 511 and a second point on the second convex portion 511 of the corresponding groove 501 along a direction 212 that is perpendicular to an elongated direction 802 (see FIG. 8), where the first point and the second point are as far apart as possible. The width of convex portions in other embodiments can be defined similarly. The maximum depth 515 of the second convex portion 511 can be the same along the length of the groove 501, perpendicular to the surface profile shown in FIG. 5. Furthermore, at the maximum depth 515 of the second convex portion 511, a surface profile of the second surface 505 may include an inflection location where the second surface 505 transitions from the second convex portion 511 to the concave portion 509. As shown in FIG. 5, the inflection location can comprise an inflection on the surface profile. Further, the inflection location can extend as an inflection line along the elongated direction 802 (see FIG. 8) of the corresponding groove 501, wherein the transition location can be between the concave portion 509 and the second convex portion 511 of the second surface 505. In some embodiments, the inflection line can be parallel to the elongated direction 802 (see FIG. 8) and/or the maximum depth 515 of the second convex portion 511 may be the same along the length of the groove 501. Although not shown, the transition location may comprise a linear profile, rather than a point. For instance, embodiments where the transition location comprises a line in the elongated direction 802 (see FIG. 8), the transition location can define a linear portion of the surface profile perpendicular to the elongated direction 802 (see FIG. 8), such as an inclined surface or other transition surface that can extend along the length of the groove between the second convex portion 511 and the concave portion 509.

The concave portion 509 of the second surface 505 can be characterized in a manner described above for other concave portions of other embodiments. As shown in FIG. 5, in some embodiments the concave portion 509 may be closer to the base 513 of the groove 501 than a second convex portion 511. Although not shown, in other embodiments, the second convex portion 511 may be closer to the base 513 of the groove 501 than the concave portion 509. Although not shown, in other embodiments, the compound shape of the second surface may comprise one or more inclined portions that can be characterized in a manner described above for other surfaces 305 comprising an inclined portion. The one or more inclined portions, if provided, may be located closer to the base 513 of the groove 501 than the concave portion 509 and second convex portion 511, located between the concave portion 509 and second convex portion 511, and/or located closer to the second major surface 111 than the concave portion 509 and the second convex portion 511. In yet other embodiments, the compound shape of the second surface 505 may comprise more than two distinct portions selected from one or more of a concave portion, a convex portion, or an inclined portion. For example, the second surface may comprise a convex portion sandwiched between two concave portions or visa versa.

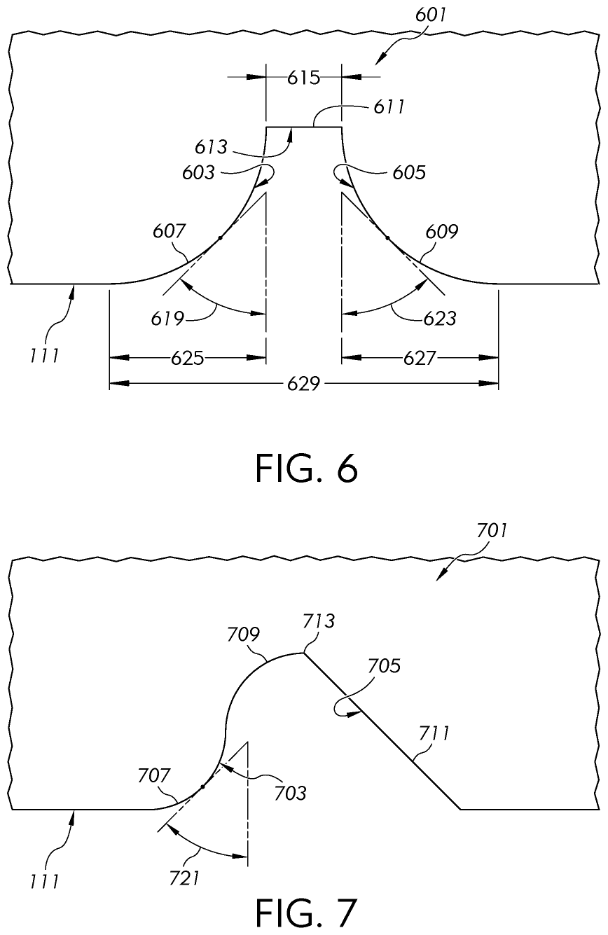

FIG. 6 illustrates another embodiment of a surface profile of a groove 601 that can comprise one or more of the shapes of a first surface 603, a second surface 605, and a base 611 shown. In some embodiments, the first surface 603 can comprise a first convex portion 607 and the second surface 605 can comprise a second convex portion 609. The first convex portion 607 and/or the second convex portion 609 can include characteristics similar or identical to the convex portions 201, 203, 309 of the grooves 117, 301 discussed above. The first convex portion 607 can be characterized by a first depth angle 619, as defined above. The second convex portion 609 can be characterized by a second depth angle 623.

A depth angle differential between the first depth angle 619 and the second depth angle 623 can be defined as an absolute value of the first depth angle 619 of the first convex portion 607 minus the second depth angle 623 of the second convex portion 609. In further embodiments, the differential may be about 5° or more, about 10° or more, about 15° or more, between about 5° and about 45°, between about 10° and about 40°, or between about 15° and about 30°. In other further embodiments, the difference may be about 5° or less, about 2° or less, or about 1° or less. In such embodiments, the first depth angle 619 and the second depth angle 623 may be about the same. Furthermore, in some embodiments, the second convex portion 609 can comprise a mirror image of the first convex portion 607 or otherwise arranged as discussed for the first and second convex portions 201, 203 of the groove 117 with respect to FIG. 2 above.

In some embodiments, the base 611 of the groove 601 comprises a base surface 613 and an associated width 615 extending between the first surface 603 and the second surface 605 in a direction parallel to the second major surface 111. As illustrated, in some embodiments, the base surface 613 can be flat but may alternatively be curved (e.g., outwardly concave) in further embodiments. For instance, as shown, the base surface 613 may comprise a substantially flat surface that can be substantially parallel to the second major surface 111, although nonparallel orientations can be provided in further embodiments. For instance, in some embodiments, the base surface 613 may comprise at least one or more flat surfaces with at least one of the flat surfaces comprising an inclined portion extending outwardly towards the second major surface 111 in a direction from the first surface 603 towards the second surface 605. In some embodiments, the base surface 613 may comprise at least one or more flat surfaces with at least one of the flat surfaces comprising an inclined portion extending inwardly away from the second major surface 111 in a direction from the first surface 603 towards the second surface 605.

In some embodiments, the width 615 of the base surface 613 can be about 50 microns or less, about 30 microns or less, about 10 microns or less, about 5 microns or less, about 2 microns or less, or about 1 micron or less. In further embodiments, the base 123, 307, 411, 513 may comprise a cusp where the first surface 119, 303, 403, 503 meets the second surface 121, 305, 405, 505 of the corresponding groove 117, 301, 401, 501 at a sharp transition location as shown in FIGS. 1-5. Likewise, a base 713 of a groove 701 discussed with respect to FIG. 7 below may comprise a cusp where a first surface 703 meets a second surface 705 at a transition location. In such embodiments, the cusp may form a cusp line along the length of the corresponding groove. Further, the width 615 of the base surface 613 of the cusp may be less than or equal to 1 micron, such as less than or equal to a surface roughness of the first surface and/or the second surface of the corresponding groove 117, 301, 401, 501, 701. In other further embodiments, a first concave portion 201 of a first surface 119 may meet a second concave portion 203 of a second surface 121 at a base 123, which can optionally comprise a cusp, as shown in FIG. 2. In yet other further embodiments, the first surface 303, 403, 503 and the second surface 305, 405, 505 may meet at a base 307, 411, 513, which can optionally comprise a cusp as shown in FIGS. 3-5. Like the width 615 of the base surface 613, any of the embodiments of the disclosure (e.g., FIGS. 2-5 and 7) may comprise a base that has a width that is larger than a cusp, for example, wherein the width is between about 1 micron and about 50 microns, about 1 micron and about 30 microns, between about 1 micron and about 10 microns, or between about 1 micron and about 5 microns. In such embodiments where the width of the base is larger than a cusp, the width of the base surface may be larger than the surface roughness of the corresponding groove.

As shown in FIG. 6, a difference between the groove width 629 and the sum of a first width 625 of the first surface 603 and a second width 627 of the second surface 605 of the corresponding groove 601 may be about the width 615 of the base 611. The groove width 629, first width 625, and second width 627 may be defined the same way as the groove width 211, first width 213, and second width 215 were defined with regards to FIG. 2, respectively. In further embodiments, the first surface 603 can comprise a first convex portion 607 and the second surface 605 can comprise a second convex portion 609, as shown in FIG. 6. In other further embodiments, the first surface 603 can comprise a first convex portion 607 and the second surface can comprise a concave portion. In yet other further embodiments, the first surface 603 can comprise a first convex portion 607 and the second surface can comprise an inclined portion. In still other embodiments, the first surface 603 can comprise a first convex portion 607 and the second surface 605 can comprise a compound shape, as described with respect to the groove 501 discussed above. The first convex portion 607 can have a first maximum depth associated with it and that first maximum depth can be the same along the length of the groove 601; the second convex portion 609 can have a second maximum depth associated with it and that second maximum depth can be the same along the length of the groove 601; and the length of the groove 601 may be perpendicular to the surface profile shown in FIG. 6.

FIG. 7 illustrates another embodiment of a surface profile of the groove 701 that can comprise one or more of the shapes of a first surface 703, a second surface 705, and a base 611. As shown, the first surface 703 can comprise a compound shape that can be a mirror image of the second surface 505 of the groove 501 and otherwise include similar or identical features as the compound shape of the second surface 505 of the groove 501 of FIG. 5 discussed above. For instance, the first surface 703 of the groove can include a convex portion 707 with a depth angle 721 similar or identical to the second convex portion 511 and corresponding depth angle 519 of the groove 501 discussed with respect to FIG. 5 above. The first surface 703 can include the convex portion 707 in combination with at least one non-convex portion selected from a concave portion 709 and an inclined portion and may further include another convex portion. For instance, in the illustrated embodiment, the non-convex portion can comprise the illustrated concave portion 509 that may be similar or identical to the concave portion 509 of the of the groove 501 discussed with respect to FIG. 5 above.

In further embodiments, the second surface 705 may comprise an inclined portion 711, as shown in FIG. 7. The inclined portion 711, if provided, can be similar or identical to the inclined portion 306 discussed with respect the groove 301 of FIG. 3 discussed above. In further embodiments, although not shown, the second surface 705 of the groove 701 can comprise a convex portion similar or identical to the first convex portions 201, 309 discussed with respect to the grooves 117, 301 of FIGS. 2 and 3 above. In other further embodiments, although not shown, the second surface 705 of the groove 701 can comprise a concave portion similar or identical to the concave portion 409 discussed with respect to the groove 401 of FIG. 4 above. In still other further embodiments, although not shown, the second surface 705 of the groove 701 can comprise a compound shape similar or identical to the compound shape of the second surface 505 of the groove 501 discussed above. In some embodiments, the compound shape of the first surface 703 can be similar to a compound shape of the second surface 705. As shown, the base 713 of the groove 701 can comprise a cusp. Alternatively, as stated previously, the base 713 of the groove 701 may comprise any other type of base discussed above that is not a cusp. Also, the first convex portion 711 can have a first maximum depth associated with it and that first maximum depth can be the same along the length of the groove 701; the inclined portion 711 can have a second maximum depth associated with it and that second maximum depth can be the same along the length of the groove 701; and the length of the groove 701 can be perpendicular to the surface profile shown in FIG. 7.

Grooves comprising any of the above surface profiles can be used in various embodiments of the light apparatus of the disclosure. The grooves can be made in a light guide plate 105 using a number of different methods including diamond turning, laser ablation, laser etching, chemical etching, molding, hot embossing, or printing.

Diamond engraving can be used to produce very precise grooves in virtually any light guide plate material. As such, diamond turning can be used to create any of the embodiments of the base discussed herein (e.g., a base comprising a cusp) and any of the embodiments of the surface profiles of the groove surfaces discussed herein (e.g., a convex portion or concave portion that includes the entire groove first surface). However, in some applications, diamond turning can be expensive process because it requires diamond-tipped tools and very accurate machining, for example with a very accurate computer numerical control (CNC) machine.

Laser ablation can be used to remove portions of a light guide plate to form grooves with a laser. A laser may comprise a pump-probe system, optical filters, lenses, mirrors, and gratings which can be used to stretch, compress, amplify, or filter the pulse. A wavelength of the laser may be tuned so that the material of the light guide plate is non-transparent at that optical wavelength, meaning that the material will absorb some of the energy emitted by the laser. For example, borosilicate glass can be ablated using ultraviolet or visible wavelength laser pulses. High intensity pulses of the laser are emitted and are characterized by a fluence and a duration. Fluence can be defined as the time-integrated flux of radiation emitted by a laser in a pulse at a surface cross-section and may have units of W/cm². Ablation usually occurs when the fluence is above a threshold value that depends on properties of both the light guide plate material and laser apparatus. Each pulse may have a very short duration, for example, about 1 microsecond or less, 10 nanoseconds or less, 5 nanoseconds or less, 1 nanosecond or less, about 500 femtoseconds or less, about 200 femtoseconds or less, or about 100 femtoseconds or less. Each pulse can remove via ablation (e.g., absorption followed by a thermalization mechanism such as vaporization, ionization, melting, or explosion) a predetermined about of material, for example 0.04 microns/pulse, in the area where the laser is aimed at with a beam radius. Generally, the pulse duration, number of pulses, and pulse repetition rate can be adjusted to control the amount of material removed and the pattern formed in the light guide plate material. Shorter pulses and slower repetition rates can be associated with less cracking or even no cracking of the light guide plate material. Laser ablation can occur in vacuum, in air, or in the presence of an inert gas. Depending on the parameters chosen, laser ablation may produce grooves with bases comprising a flat bottom or surfaces comprising a compound shape with a convex portion closer to the second major surface of the light guide plate and a concave portion closer to the base of the groove. Additional control of the resulting groove shape may be obtained using plasma assisted laser ablation or flow supported laser ablation.

Longer laser pulses can be used to create grooves via laser etching. One method can allow the laser to melt portions of the light guide plate 105 material. Typically, an infrared laser such as a carbon dioxide or YAG (neodymium-doped yttrium aluminum garnet) laser is used to heat the light guide plate 105 material in preselected areas. Another method for using a laser to create grooves is a form of laser etching called laser-induced back-side wet etching (LIBWE). In LIBWE, selected portions of the second major surface 111 of the light guide plate 105 can be contacted with thin liquid layers, which absorb pulse energy from a laser to etch the light guide plate 105. LIBWE can effectively etch crack-free grooves in transparent materials with high precision. Various organic dyes and inorganic pigments can be used as photoetchants. Either form of laser etching can lead to smooth irregularities in the surfaces of a groove. Additionally, a flat base surface may be formed in some grooves.

Chemical etching can be used to remove portions of a light guide plate to form grooves by controlling the locations of and exposure times to various chemicals. To make some embodiments, a removable mask may be deposited on a portion of the second major surface 111 of the light guide plate 105 in areas that will not be part of a groove. Then, the light guide plate 105 can be placed into a controlled chamber where it is exposed to an etchant. The exposure time as well as the concentration profile of the etchant can control the resulting groove shape. After etching, the mask can be removed. In some embodiments, the mask can limit the area etched by the etchant. For example, the mask may comprise a quantity of boron or polymer. In other embodiments, a mask may not need to be deposited on the second major surface 111 of the light guide plate 105. Instead, a mask may be used to shape the distribution of the etchant. Sometimes, a mask may not be needed at all. In some processes, the etchant may be a liquid that is effective to etch the material of the light guide plate 105 but not the material of the mask. For example, the etchant may be an acid like HF or a base like NaOH. In other embodiments, the etchant may be applied as a gas. For example, HF gas may be applied in a controlled chamber. In yet other embodiments, the etchant may be a plasma. In still other embodiments, the etchant may be generated by a light source. When a mask is used, it may be removed via several different techniques depending on the composition of the mask. For example, the mask may be oxidized through plasma exposure. Alternatively, the mask may be removed by ashing. Still further, a solvent, for example 1-methyl-2-pyrrolidone (NMP), may be used to remove the mask. Using such chemical etching procedures can produce a rounded groove base or compound surfaces where a concave portion is closer to the base. If the etchant exposure is longer, over-etching can occur producing a groove shape that turns back on itself before reaching the groove base.

Grooves can also be formed in a light guide plate through molding, hot embossing, or printing. For instance, a molten material can be poured into a mold with the desired surface profile for the second major surface 111 of the light guide plate 105. Once cooled, the light guide plate 105 can be removed from the mold and the first major surface can be machined. In other embodiments, the light guide plate 105 could be hot embossed. Alternatively, the light guide plate 105 could be inkjet or three-dimensionally (3D) printed to form the desired groove shape. In one embodiment, the light guide plate 105 can be made of a single material that is formed in a single molding or printing process. In another embodiment, a portion of the light guide plate 105 including the second major surface 111 can be molded or printed separate from the rest of the light guide plate 105. In further embodiments, a first portion of the light guide plate 105 including the second major surface 111 may comprise a different material than a second portion comprising the rest of the light guide plate 105. In even further embodiments, the first portion can comprise polymer and the second portion can comprise an amorphous inorganic material, or a crystalline material. Separate processing for the first portion and the second portion of the light guide plate 105 may be desirable to reduce overall processing costs. Likewise, molding may be desirable when cost is to be minimized.

Referring to FIG. 1, embodiments of the light apparatus of any of the embodiments may include a light source 103 that can face the first edge 107 of the light guide plate 105. In some embodiments, the first surface 119, 303, 403, 503, 603, 703 may be closer to the light source 103 than the second surface 121, 305, 405, 505, 605, 705 of the corresponding groove 117, 301, 401, 501, 601, 701 as shown in FIG. 1. In some embodiments, the light source 103 can comprise a luminescent light such as an array of light emitting diodes (LEDs). In further embodiments, the light source 103 can comprise an incandescent light or an electrical discharge light. The light source 103 can comprise a luminescent diode, a bulb, or a laser. Example diodes include, without limitation, light emitting diodes (LEDs) comprising inorganic semiconductor materials, small molecule organic light emitting diodes (OLEDs), and polymer light emitting diodes (PLEDs). Examples of bulbs include, without limitation, incandescent bulbs including tungsten filamented bulbs, gas filed discharge tubes including fluorescent, neon, argon, xenon, and high-energy arc discharge lamps. Examples of lasers include, without limitation, helium-neon, argon, krypton, ruby, copper vapor, gold vapor, manganese vapor, and dye lasers. In some embodiments, diodes may be preferable as a light source 103 in embodiments where a compact shape and lower energy consumption are desired. In other embodiments, a fluorescent light source may be preferable when cost is to be minimized. In further embodiments, the light source 103 can include a light conduit configured to deliver light to the first edge 107 of the light guide plate 105. For instance, the light source 103 can comprise optical fiber(s) to deliver light to the first edge 107. In further embodiments, a light source 103 may be positioned to deliver light to the first edge 107.

FIG. 8 illustrates an example embodiment of a cross-section taken along the line 8-8 in FIG. 1 showing a direction 803 of light emitted from the light source 103 going toward the first edge 107. In some embodiments, the light source 103 can be positioned to emit light at least partially in a direction 803 perpendicular to the first edge 107, although oblique (i.e., non-perpendicular) directions are possible in further embodiments. In some embodiments, a first groove 117, 301, 401, 501, 601, 701 may be spaced apart from an adjacent second groove 811 by a first spacing 817. In further embodiments, the first spacing 817 may be about 5 microns or more, about 10 microns or more, about 20 microns or more, about 50 microns or more, or about 100 microns or more. In other further embodiments, the first spacing 817 may be about 5 millimeters or less, about 2.5 millimeters or less, about 1 millimeter or less, about 500 microns or less, about 200 microns or less, about 100 microns or less, or about 50 microns or less. In yet other further embodiments, the first spacing 817 may be between about 5 microns and about 5 millimeters, between about 5 microns and about 2.5 millimeters, between about 10 microns and about 2.5 millimeters, between about 10 microns and about 1 millimeter, between about 20 microns and about 1 millimeter, between about 50 microns and about 1 millimeter, between about 50 microns and about 500 microns, or between about 20 microns and about 200 microns. In some embodiments, the grooves 117, 301, 401, 501, 601, 701, 811 can include a length extending in an elongated direction 802 that may be substantially parallel to the first edge 107 and perpendicular to a direction of the length 112 of the light guide plate 105.

In other embodiments, a second spacing 819 between a second pair of adjacent grooves can be defined. In further embodiments, the first spacing 817 between a first pair of adjacent grooves (e.g., 117, 301, 401, 501, 601, 701, 811) can be the same as the second spacing 819 between a second pair of adjacent grooves. In other further embodiments, the first spacing 817 may be greater than the second spacing 819 when the first pair of adjacent grooves 117, 301, 401, 501, 601, 701, 811 is closer to the first edge 107 of the light guide plate 105 than the second pair of adjacent grooves. Such a spacing pattern provides the technical benefit of evenly distributing light between the grooves 117, 301, 401, 501, 601, 701, 811 because the grooves 117, 301, 401, 501, 601, 701, 811 are denser in places with lower light intensity. Without wishing to be bound by theory, light intensity decreases with the inverse square of the distance from a light source in the absence of any objects; in a light guide plate 105, the light intensity may decrease exponentially with distance as light is reflected off of the plurality of grooves 117 and exits the light guide plate 105. In still further embodiments, this relationship between spacings of pairs of adjacent grooves can hold for all spacings of adjacent grooves. In other words, the spacings 817, 819 between pairs of adjacent grooves along the length 112 of the light guide plate 105 can decrease as a distance of the adjacent pair of grooves from the first edge 107 increases. This spacing can range between about 5 microns to about 5 millimeters, between about 10 microns to about 2.5 millimeters, between about 10 microns and about 1 millimeter, between about 10 microns and about 500 microns, between about 20 microns and about 1 millimeter, or between about 20 microns and about 500 microns. In some embodiments, the maximum depth of each groove of the plurality of grooves 117 can increase as the distance from the corresponding groove to the light source 103 increases. In other embodiments, the maximum depth of each groove of the plurality of grooves 117 can increase as the distance from the corresponding groove to the first edge 107 of the light guide plate 105 increases. In other embodiments, the depth angle of at least one surface of each groove of the plurality of grooves 117 can change as a function of the distance between the corresponding groove and the first edge 107 of the light guide plate 105. In some further embodiments, the depth angle may increase linearly as the distance between the corresponding groove and the first edge 107 of the light guide plate 105 increases. In other further embodiments, the depth angle may decrease linearly as the distance between the corresponding groove and the first edge 107 of the light guide plate 105 increases.

In further embodiments, as shown in FIG. 8, the length of one or more of the grooves 117, 301, 401, 501, 601, 701, 811 can be equal to or greater than the width 813 of the light guide plate 105. For example, in some embodiments where the grooves extend in the elongated direction 802 of the width 813, the length of one or more of the grooves may be equal to the width 813 of the light guide plate 105. Alternatively, in some embodiments where the grooves extend in a direction that is not equal to the elongated direction 802 of the width 813, the length of the grooves may be greater than the width 813 of the light guide plate 105. In some embodiments, the length of one or more of the grooves extends through at least one or both of the third edge 807 and the fourth edge 809. For instance, as shown in FIG. 8, all the grooves extend continuously and uninterrupted from and through the third edge 807 to and through the fourth edge 809. In some embodiments, the length of one or more of the grooves can be about 50 microns or more, about 100 microns or more, about 200 microns or more, or about 500 microns or more, about 1 millimeter or more, about 10 millimeters or more, about 100 millimeters or more, about 500 millimeters or more, about 1000 millimeters or more, or about 2000 millimeters or more.

As discussed above with respect to FIG. 8, the length of one or more of the grooves can be about 100% of the width 813 of the light guide plate and may extend through one or both of the third edge 807 and the fourth edge 809. FIG. 9 illustrates an alternative embodiment, where one or more of the grooves optionally extends through only one of the third edge 807 and the fourth edge 809 and in some embodiments, as shown, extends less than the width 813 of the light guide plate 105. For instance, in embodiments where one or more of the grooves extends in the direction of the width 813, the grooves 117, 301, 401, 501, 601, 701, 811 may include a groove length 912 that can extend between about 10% and about 100%, between about 20% and about 90%, between about 25% and about 75%, between about 10% and about 50%, or between about 15% and about 25% of the width 813 of the light guide plate 105.

As further illustrated in FIG. 9, in some embodiments, at least one groove path 903a, 903b may include one or more grooves on the path. Throughout the disclosure, a groove is considered on a groove path when the length of the corresponding groove extends along the groove path and the base of the corresponding groove is positioned on the groove path. In embodiments where a plurality of grooves is on a common path, the grooves may be spaced apart along the groove path. In further embodiments, the groove paths 903a, 903b may be parallel to one another and/or can comprise substantially straight paths. For instance, FIG. 9 illustrates groove paths 903a, 903b that are straight, parallel with respect to one another, and can be parallel to the first edge 107 of the light guide plate 105, as shown. Furthermore, each groove path can comprise a plurality of aligned grooves, although one or more groove paths may only include a single groove in further embodiments. For instance, FIG. 9 illustrates a first groove path 903a and a second groove path 903b, each groove path including a corresponding plurality of grooves 909a, 909b that on the respective groove paths 903a, 903b and are spaced apart from one another along the respective groove paths 903a, 903b. Indeed, the plurality of grooves 909a on the first groove path 903a can spaced apart from one another by a distance 911. In some embodiments, the distance 911 between each groove in the first groove path 903a can be the same, although different distances 911 may be provided in further embodiments.

In further embodiments, the plurality of grooves 909b of the second groove path 903b can be on the second groove path 903b and spaced apart from one another by a distance 913. In some embodiments, the distance 911 between each groove in the first groove path 903a can be the same, although different distances may be provided in further embodiments. In some embodiments, the distance 913 between each groove in the second groove path 903b can be the same, although different distances may be provided in further embodiments. Furthermore, the distance 911 between the grooves 909a of the first groove path 903a may be the same or different than the distance 913 between the grooves 909b of the second groove path 903b. The distance 911, 913 between the grooves 909a, 909b can be about 10 microns or more, about 20 microns or more, about 50 microns or more, or about 100 microns or more. In other further embodiments, the distance 911, 913 between the grooves 909a, 909b can be about 100 millimeters or less, about 50 millimeters or less, about 25 millimeters or less, about 10 millimeters or less, about 5 millimeters or less, about 2.5 millimeters or less, about 1 millimeter or less, or about 500 microns or less. In yet other further embodiments, the distance 911, 913 can be between about 10 microns and about 100 millimeters, between about 10 microns and about 50 millimeters, between about 10 microns and about 25 millimeters, between about 10 microns and about 10 millimeters, between about 10 microns and about 2.5 millimeters, between about 20 microns and about 2.5 millimeters, between about 50 microns and about 2.5 millimeters, between about 100 microns and about 2.5 millimeters, between about 20 microns and about 1 millimeter, between about 50 microns and about 1 millimeter, or between about 50 microns and about 500 microns.

The groove length 912 of each groove of the plurality of grooves 909a and/or grooves 909b may be the same or different from one another. In addition, the profiles of the grooves 909a, 909b and 811 of FIGS. 8 and 9 can comprise the profile of any of the grooves 117, 301, 401, 501, 601 or 701 or other grooves in accordance with the disclosure.

As further shown, the spacing 915 between the groove paths 903a, 903b may or may not have the same attributes as the spacings 817, 819 discussed above in conjunction with FIG. 8. In other further embodiments, one or more grooves 909a of the first groove path 903a may be staggered relative to one or more grooves 909b of the adjacent second groove path 903b in the direction of the width 813 of the light guide plate 105 such that a spacing defined by the distance 911 between an adjacent pair of grooves 909a of the first groove path 903a is not aligned with a spacing defined by the distance 913 between an adjacent pair of grooves 909b of the second groove path 903b along a direction of the length 112 of the light guide plate 105 and/or perpendicular to the first edge 107 of the first light guide plate. Such a staggered design can provide the technical benefit of distributing the light leaving the light guide plate 105 more evenly along the length 112 of the light guide plate 105 than having grooves 909a, 909b aligned between groove paths 903a, 903b.

Referring back to FIG. 1, in some embodiments, the light apparatus 101 may optionally further comprise a display 115. In such embodiments, the display 115 may be a liquid crystal display (LCD) or a similar display that may benefit from external illumination. As further illustrated in FIG. 1, in some embodiments, the display 115 may comprise a reflector 113. In such embodiments, the reflector 113 can comprise a material that is inherently reflective such as aluminum, steel, or silver. In other such embodiments, the reflector 113 can comprise a material such as polyethyleneterephthalate (PET) or polycarbonate (PC) that is reflective when placed adjacent to another material in the light apparatus 101 having a different refractive index. In some embodiments, the reflector 113 may comprise an average reflectance over a wavelength range from about 400 nm to about 700 nm of about 90% or more, about 95% or more, about 96% or more, or about 98% or more. In some embodiments, the reflector 113 can face the second major surface 111 of the light guide plate 105, as shown in FIG. 1.

As configured in FIG. 1, the display 115 can be backlit by light exiting the light guide plate 105 from the light source 103. In other embodiments, the light guide plate 105 may be on the other side of the display 115 to frontlight the display 115. Also, the light source 103 is shown as facing the first edge 107 of the light guide plate 105 so that the light guide plate 105 is edgelit. In other embodiments, the light guide plate 105 may be backlit by a light source positioned between the second major surface 111 of the light guide plate 105 and the reflector 113 or in place of the reflector 113. In yet other embodiments, the light source 103 may face another edge (e.g., the second, third and/or fourth edge 110, 807, 809) of the light guide plate 105.

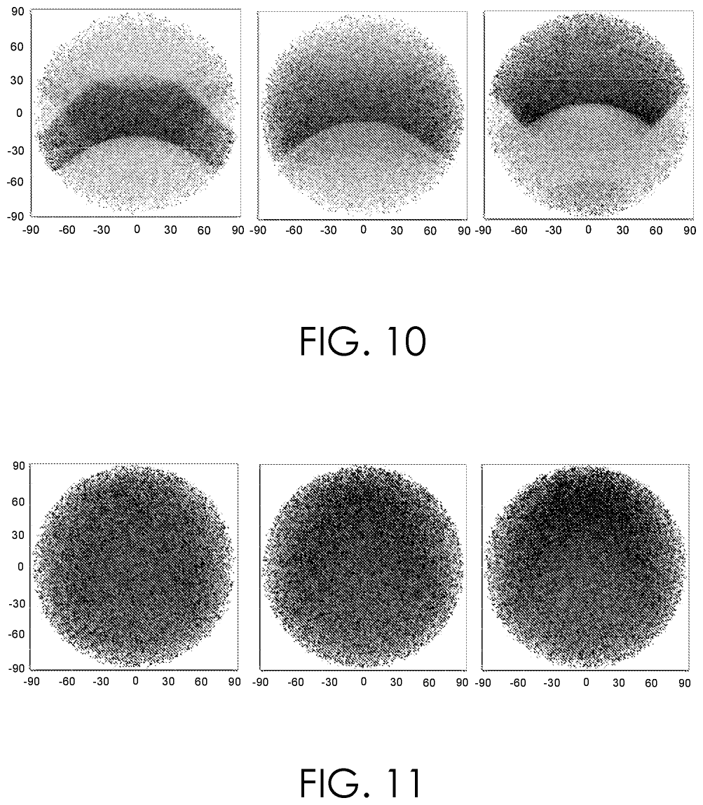

As used to describe FIGS. 10-13, the term “vertical” refers to a direction running from the light source 103 towards the first edge 107 of the light guide plate 105 while the term “horizontal” refers to a direction perpendicular to the “vertical” direction and a direction normal to the first major surface 109 of the light guide plate 105.

FIG. 10 illustrates an angular distribution of light leaving the first major surface of a light guide plate according to embodiments described herein when the second major surface has inclined grooves with a maximum depth of 5 microns for different depth angles. For each sub-plot, the x-axis (i.e., horizontal axis) is the horizontal angle in degrees relative to a direction normal to the first major surface of the light guide plate while the y-axis (i.e., vertical axis) is the vertical angle in degrees relative to a direction normal to the first major surface of the light guide plate. The gray-value plotted corresponds to a radiance in W/m² running from white for 0 W/m² to black for a maximum value. Going from left to right, the depth angle of each surface of an inclined groove is 35°, 45°, and 55°. For a depth angle of 35°, the maximum radiance occurs at the bottom of a downward facing parabolic arc running between −30° to −20° on the vertical axis across the horizontal axis. For a depth angle of 45°, the peak radiance is localized in bands between −60° to −30° and 30° to 60° on the horizontal axis. For a depth angle of 55°, these bands concentrate around −60° and 60° on the horizontal axis and a slightly positive value on the vertical axis. In the vertical direction, the general trend is that for smaller depth angles (i.e., below 35°—not shown) the peak radiance is concentrated around −60° to −30° and the vertical angle increases with increasing depth angle. In the horizontal direction, the general trend is that the maximum radiance is centered for depth angles around 35° but the maximum radiance bifurcates towards −60° and 60° further away from a depth angle of 35°.

FIG. 11 illustrates an angular distribution of light leaving the first major surface of a light guide plate according to embodiments described herein when the second major surface has concave grooves with a maximum depth of 5 microns for different depth angles. For each sub-plot, the x-axis (horizontal axis) is the horizontal angle in degrees relative to a direction normal to the first major surface of the light guide plate while the y-axis (vertical axis) is the vertical angle in degrees relative to a direction normal to the first major surface of the light guide plate. The gray-value plotted corresponds to a radiance in W/m² running from white for 0 W/m² to black for a maximum value. Going from left to right, the depth angle for each surface of a concave groove is 35°, 45°, and 55°. For a depth angle of 35°, the radiance resembles and upside-down “U” with a maximum intensity around −75° vertical and 0° horizontal. For a depth angle of 45°, the radiance is more tightly clustered around the same location of maximum radiance. For larger depth angles (e.g., 55°), this trend of localizing at −75° vertical continues. For smaller depth angles (e.g., less than 35°), the radiance is more diffuse and forms an “O”-shape with very little radiance in the middle (i.e., angles near normal).

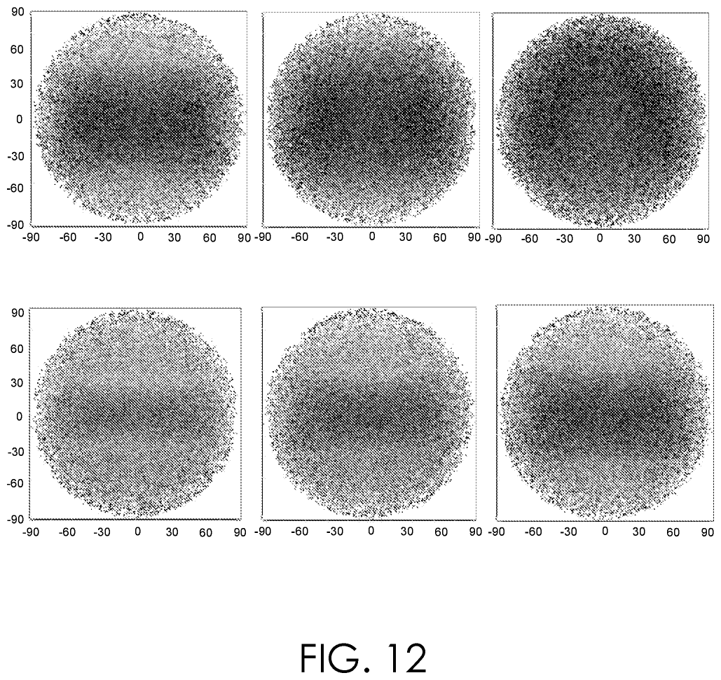

FIG. 12 illustrates the angular distribution of light leaving the first major surface of a light guide plate according to embodiments described herein when the second major surface has convex grooves with a maximum depth of 5 microns for different depth angles. For each sub-plot, the x-axis (horizontal axis) is the horizontal angle in degrees relative to a direction normal to the first major surface of the light guide plate while the y-axis (vertical axis) is the vertical angle in degrees relative to a direction normal to the first major surface of the light guide plate. The gray-value plotted corresponds to a radiance in W/m² running from white for 0 W/m² to black for a maximum value. In the top row, the depth angle for each convex groove is 35°, 45°, and 55°, going from left to right. In the bottom row, the depth angle for each convex groove is 20°, 25°, and 30°. For a depth angle of 35°, the radiance is highest in a rectangle between −30° and 30° in the vertical direction between −60° and 60° in the horizontal direction. The maximum radiance appears to be around normal (i.e., 0°) in both directions. For higher depth angles (e.g., 45°), the radiance bifurcates into clusters around −45° and 45° in the horizontal direction that eventually fan out to form an upside-down “U” shape at even higher depth angles (e.g., 55°).

Of the groove designs examined, only the convex groove design had a maximum radiance near normal in both directions. The lower row of FIG. 12 shows the angular distribution for convex grooves with depth angles less than 35°. For a depth angle of 30°, the radiance distribution is very similar to that for 35°, namely centered around normal incidence vertically and covering a wide band horizontally. For a depth angle of 25°, the shape of the distribution is largely the same, but the intensity appears to be less than for 30°. For a depth angle of 30°, the intensity has fallen off dramatically. As such, a convex groove design with a depth angle between 25° and 45° appears to give a maximum radiance at near normal angles in both the vertical and horizontal directions. Moreover, such a groove design will optimally illuminate a display for a viewer whose eyes are aligned in the horizontal direction of FIGS. 10-12 (i.e., perpendicular to the length of the groove).

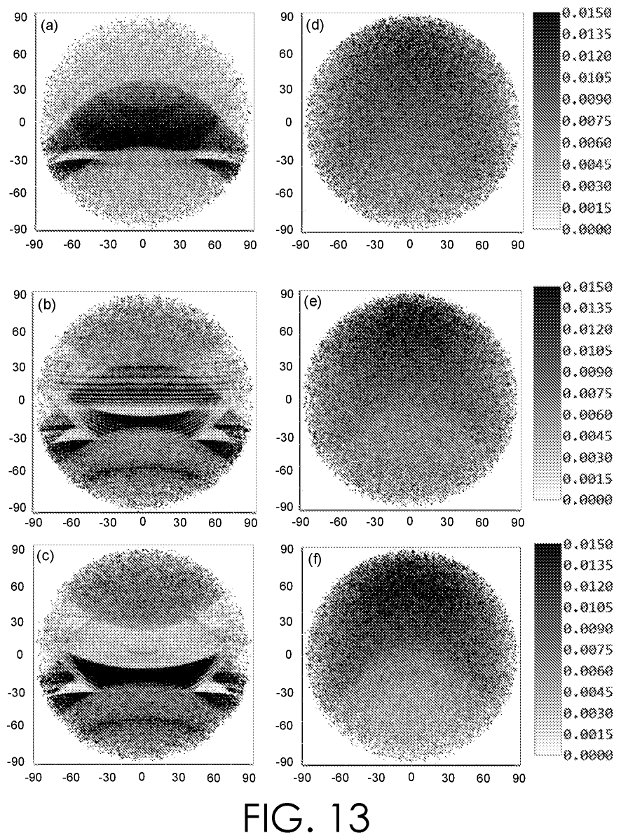

The radiance behavior described for the convex grooves is unexpected. At the same 5-micron groove size, the other groove designs were not able to achieve comparable behavior. FIG. 13 illustrates the angular distribution of light leaving the first major surface of a light guide plate according to embodiments described herein when the second major surface has either angled or concave grooves with a depth angle of 35° for different maximum depths. For each sub-plot, the x-axis (horizontal axis) is the horizontal angle in degrees relative to a direction normal to the first major surface of the light guide plate while the y-axis (vertical axis) is the vertical angle in degrees relative to a direction normal to the first major surface of the light guide plate. The gray-value plotted corresponds to a radiance in W/m² running from white for 0 W/m² to black for a maximum value for each row of sub-plots. The left column corresponds to angled grooves while the right column corresponds to concave grooves. Going from top to bottom, each row corresponds to a maximum depth of each groove of 50 microns, 250 microns, and 500 microns. For maximum depths of 50 and 500 microns, the radiance from the concave groove design has maxima around vertical angles of −45° and −30° and horizontal angles of −45°, −30°, 30°, and 45°. For a maximum depth of 250 microns, the radiance from the concave groove design has a maximum around −30° vertical and around 0° horizontal. For all maximum depths, the concave groove design does not have any location of notable radiance. As such, changing the maximum depth for inclined and concave groove designs still cannot achieve the unexpected results obtained with the convex groove designs.

With reference to FIG. 1, light guide plates with convex grooves can be used as part of a light apparatus in a method of emitting light. First, light emitted from the light source 103 can be injected into the first edge 107 of the light guide plate 105. Then, the injected light can propagate within the light guide plate 105 by total internal reflection. Subsequently, the propagating light can pass through the first major surface 109 of the light guide plate 105 with a peak radiance oriented from about 0° to about 30° from a direction normal to the first major surface 109 of the light guide plate 105. In further methods, the propagating light can pass through the first major surface 109 of the light guide plate 105 with a peak radiance oriented from about 0° to about 10° from a direction normal to the first major surface 109 of the light guide plate 105.

Without wishing to be bound by theory, light can propagate within a light guide plate 105 by total internal reflection when the angle of incidence relative to the normal of an interface is greater than a critical angle. An example of a reflected light ray 125 that reflects with the light guide plate and exits through the first major surface is shown FIG. 1. When light has an angle of incidence less than the critical angle for that interface, a portion of the light will be reflected while the remainder will refract through the material on other side of the interface. Without wishing to be bound by theory, the proportion of light reflected or refracted can be calculated using the Fresnel equations. The light may propagate within the material on the side of the interface at a different angle than it was incident on the interface. Further, the refracted light may be incident upon a second interface that it can further refract through. More concretely, some light within the light guide plate 105 may refract into the groove 117. Typically, this refracted light is assumed to be lost. However, in some embodiments (e.g., having groove profiles of the present disclosure), the refracted light through the first surface of the groove may be able to reenter the light guide plate 105 by refracting through the second surface of the groove 117 that it left the light guide plate 105 through. A simplified example of a refracted light ray 127 that leaves and renters the light guide plate 105 through a groove 117 is shown in FIG. 1. This light can further propagate again within the light guide plate 105 by total internal reflection before exiting through the first major surface 109 of the light guide plate 105 after reflecting off of another groove of the plurality of grooves 117.

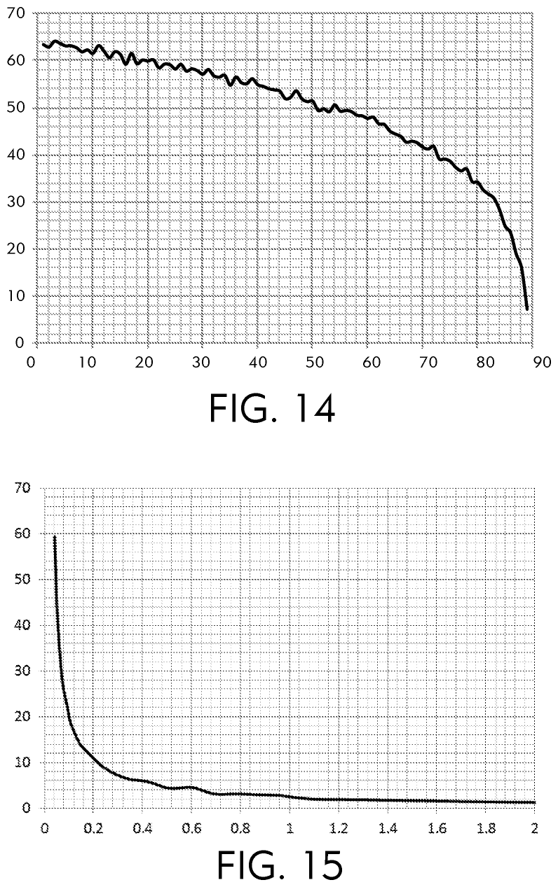

FIG. 14 illustrates the percentage of light exiting the light guide plate into a convex groove that is directed back into the light guide plate as a function of a depth angle of the second convex portion of the second surface of the convex groove, according to embodiments described herein (e.g., see FIG. 1). The x-axis (horizontal axis) is the depth angle of the second convex portion 203 of the second surface 121 of a groove 117. The groove 117 also comprises a first surface 119 further comprising a first convex portion 201. For FIG. 14, the maximum depth of the groove 117 is 30 microns and the depth angle of the first convex portion is 35°. The y-axis (vertical axis) is the percentage of light directed back into the light guide plate. In FIG. 14, the percentage of light directed back into the light guide plate 105 increases as the depth angle of the second convex portion 203 decreases. At least 50% of the light is directed back into the light guide plate 105 for a depth angle of the second convex portion 203 of about 55°. At least 55% of the light is directed back into the light guide plate 105 for a depth angle of the second convex portion 203 of about 40°. At least 60% of the light is directed back into the light guide plate 105 for a depth angle of the second convex portion 203 of about 20°. In other embodiments where the second convex portion has a depth angle of less than 35°, even more light can be directed back into the light guide plate than shown in FIG. 14.

FIG. 15 illustrates the percentage of light exiting the light guide plate into a convex groove that is directed back into the light guide plate as a function of a width of the groove, according to embodiments described herein. The x-axis (horizontal axis) is the groove width in millimeters. The y-axis (vertical axis) is the percentage of light directed back into the light guide plate. In FIG. 15, the groove with a maximum depth of 30 microns comprises a first surface further comprising a first convex portion with a depth angle of 35°, a second surface further comprising a second convex portion with a depth angle of 35°, and a base with a variable width. When the base is a cusp, the groove width is 42 microns. For a groove width of 42 microns, about 60% of the refracted light is directed back into the light guide plate. For a groove width of about 80 microns, about 25% of the refracted light is directed back into the light guide plate. For a groove width of 100 microns, about 20% of the refracted light is directed back into the light guide plate.

Light guide plates according to embodiments described herein can be used as part of a light apparatus in a method of emitting light. First, light emitting from the light source 103 can be injected into the first edge 107 of the light guide plate 105. Then, the injected light can propagate within the light guide plate 105 by total internal reflection. However, a portion of the light may exit the light guide plate 105 through at least one groove 117, 301, 401, 501, 601, 701. Yet, a portion of the light that exits through a groove 117, 301, 401, 501, 601, 701 can be directed back into the light guide plate 105. The percentage of the light directed into the light guide plate 105 can impact the angular distribution of light leaving the first major surface 109. In some embodiments, the light apparatus 101 may not comprise a reflector 113. In such embodiments, the refracted light leaving a first surface of the groove 117, 301, 401, 501, 601, 701 can only be recovered by reentering the light guide plate 105 through another surface of the corresponding groove 117, 301, 401, 501, 601, 701. Grooves with a maximum depth of less than about 50 microns, less than about 30 microns, less than about 20 microns, or between about 1 micron and about 50 microns, between about 5 microns and about 50 microns, between about 1 micron and about 30 microns, or between about 5 microns and about 30 microns may be preferable. In other embodiments, the depth angle of a convex, inclined, or concave portion of the second surface of a groove less than 50°, less than 40°, less than 30°. less than 20°, or less than 10° may be preferable. In other embodiments, the width of the base surface of a groove less than 100 microns, less than 50 microns. less than 25 microns, or less than 10 microns may be preferable. In some embodiments, the portion of light exiting a groove 117, 301, 401, 501, 601, 701 that is directed back into the light guide plate 105 may be about 20% or more, about 30% or more, about 40% or more, about 50% or more, about 60% or more, or about 65% or more. In other embodiments, the portion of light exiting a groove 117, 301, 401, 501, 601, 701 that is directed back into the light guide plate 105 may be between 20% and 90%, between 30% and 90%, between 40% and 90%, between 50% and 90%, between 20% and 75%, between 30% and 75%, between 40% and 75%, between 50% and 75%, between 30% and 65%, between 40% and 65%, or between 50% and 65%.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. If a numerical value or end-point of a range in the specification recites “about,” the numerical value or end-point of a range is intended to include two embodiments: one modified by “about,” and one not modified by “about.” It will be further understood that the endpoints of each of the ranges are significant both in relation to the other endpoint, and independently of the other endpoint.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, as defined above, “substantially similar” is intended to denote that two values are equal or approximately equal. In some embodiments, “substantially similar” may denote values within about 10% of each other, for example within about 5% of each other, or within about 2% of each other.

As used herein, the terms “comprising” and “including”, and variations thereof, shall be construed as synonymous and open-ended, unless otherwise indicated.

It should be understood that while various embodiments have been described in detail with respect to certain illustrative and specific examples thereof, the present disclosure should not be considered limited to such, as numerous modifications and combinations of the disclosed features are possible without departing from the scope of the following claims.

What is claimed is:

1. A light apparatus comprising:
a light guide plate comprising a first major surface, a second major surface, and a first edge extending between the first major surface and the second major surface, the second major surface comprising a plurality of grooves, each groove of the plurality of grooves comprising a first surface and a second surface opposed to the first surface, the first surface of each groove comprising a first convex portion, and a maximum depth of each groove is defined between the second major surface and a base of the corresponding groove; and
a light source positioned to emit light into the first edge of the light guide plate.

2. (canceled)

3. The light apparatus of claim 1, wherein a depth angle of the first convex portion of the first surface of each groove is from about 10° to about 55°.

4. The light apparatus of claim 1, wherein the first convex portion of the first surface of each groove comprises a radius of curvature.

5. The light apparatus of claim 4, wherein the radius of curvature of the first convex portion of the first surface of each groove is equal to the maximum depth of the corresponding groove.

6. The light apparatus of claim 1, wherein the first convex portion of the first surface of each groove is closer to the light source than the second surface of the corresponding groove.

7. The light apparatus of claim 1, wherein the second surface of each groove comprises a second convex portion.

8. The light apparatus of claim 7, wherein a depth angle of the second convex portion of the second surface of each groove is from about 1° to about 55°.

9. The light apparatus of claim 3, wherein the depth angle of the first convex portion of the first surface of each groove of the plurality of grooves changes as a function of a distance of the groove from the first edge.

10. The light apparatus of claim 7, wherein the depth angle of the first convex portion of the first surface and the depth angle of the second convex portion of the second surface is the same for each groove.

11. The light apparatus of claim 7, wherein the first convex portion of the first surface and the second convex portion of the second surface of each groove meet at the base.

12. The light apparatus of claim 1, wherein the pair of surfaces of each groove of the plurality of grooves meets at the base.

13. The light apparatus of claim 1, wherein the base comprises a cusp.

14. (canceled)

15. The light apparatus of claim 1, wherein a reflector faces the second major surface of the light guide plate.

16. The light apparatus of claim 1, wherein the grooves of the plurality of grooves are spaced apart from one another and extend substantially parallel to the first edge.

17. (canceled)

18. (canceled)

19. (canceled)

20. The light apparatus of claim 1, wherein the first and second major surfaces of the light guide plate each comprise a quadrilateral shape, the light guide plate further comprising a second edge extending between the first and second major surfaces and opposite the first edge, a third edge extending from the first edge to the second edge, and a fourth edge opposite the third edge, a length of the light guide plate defined between the first edge and the second edge, and a width of the light guide plate defined between the third edge and the fourth edge.

21. The light apparatus of claim 20, wherein a spacing between pairs of adjacent grooves of the plurality of grooves along the length of the light guide plate decreases as a distance of the pair of adjacent grooves from the first edge increases.

22. The light apparatus of claim 20, wherein the spacing between the pairs of adjacent grooves along the length of the light guide plate is from about 10 micrometers to about 5 millimeters.

23. (canceled)

24. (canceled)

25. (canceled)

26. (canceled)

27. A method of emitting light with the light apparatus of claim 1, comprising:
injecting light emitted from the light source through the first edge of the light guide plate and into the light guide plate;
propagating the light injected into the light guide plate by total internal reflection, at least a portion of the propagating light exiting the light guide plate into at least one groove of the plurality of grooves; and
wherein at least 20% of the propagating light exiting the light guide plate into the at least one groove is directed back into the light guide plate.

28. The method of claim 27, further comprising passing the light propagating in the light guide plate through the first major surface of the light guide plate with a peak radiance oriented from 0° to 30° from a direction normal to the first major surface of the light guide plate.

29. The method of claim 27, wherein at least 50% of the propagating light exiting the light guide plate into the at least one groove is directed back into the light guide plate.

30. (canceled)

31. (canceled)
